(19) United States
(12) Patent Application Publication
(10) Pub. No.: US 2006/0101124 A1
(43) Pub. Date: May 11, 2006

(54) Method and apparatus for mass email transmission

(76) Inventor: Michael D. Landis, Swannanoa, NC (US)

Correspondence Address: Michael D. Landis, 113 Woodburn Dr, Swannanoa, NJ, 28778, US

(21) Appl. No.: 11/269,497

(22) Filed: Nov. 7, 2005

Related U.S. Application Data
(60) Provisional application No. 60/626,736, filed on Nov. 10, 2004.

(51) Int. Cl. G06F 15/16

(52) U.S. Cl. 709/206

(57) ABSTRACT

A method for mass email transmission in a client-server environment is provided that includes preparing and sending at least one email content by a client computer over a protocol not traditionally designed for email transmission that is received by a bulk emailing server computer using the non-email protocol. The bulk emailing server, preparing at least one bulk email message based on the received email content and then populates a bulk email recipient list with at least one destination email address that is used by the bulk emailing server for sending a plurality of at least one email massages to an email destination address in the bulk email recipient list, wherein the bulk email sending is performed using a standard email protocol.

### CROSS-REFERENCE TO RELATED APPLICATIONS

The present Utility patent application claims priority benefit of the U.S. provisional application for patent No. 60/626,736 filed on Nov. 10, 2004 under 35 U.S.C. 119(e).

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### FIELD OF THE INVENTION

The present invention relates generally to the mass transmission of email. More particularly, the invention relates to the mass transmission of email that does not require standard email Internet protocols.

### BACKGROUND OF THE INVENTION

Companies and organizations need to communicate with their customers and members frequently via email. Currently there are two methods in use for performing this task: desktop applications and email web services. Desktop applications use a data source on a workstation and generate email messages, sending them via standard email internet protocols (SMTP) to a server for delivery, scheduling the email with a built-in SMTP server, or sending the message directly to the recipient mail server also via standard internet email protocols.

With conventional desktop sending applications, the ISP bears the burden for email delivery, either directly or indirectly through the sender's own email server. In both cases, ISPs do not have the ability to certify their users adequately to avoid email abuse. Many ISPs have begun to block the network ports used for sending email through other servers for this reason, and strictly limit the volume of email sent through their own mail servers. Additionally, conventional desktop email servers use SMTP or proprietary protocols, which do not compress the email content sent. Compression of each email saves considerable bandwidth, reducing costs and increasing sending performance.

As a result of limited bandwidth and efforts to combat unsolicited commercial email, ISPs are forcing senders to use web-based email services. Mass email services require that the data source itself be loaded onto, stored, or communicated to the mass email generation server, and the email generation server itself generates the emails and sends them.

Some email services work in conjunction with desktop applications to connect to the data source and send selected fields from a database to the server for generation and delivery. In all current cases, utilization of email services imposes a separation between the sending activity on the server and the data source on the sender's workstation. This separation makes integration of sending with the sender's workstation difficult to implement and manage.

While ISPs have begun to block port 25 for SMTP (Simple Mail Transfer Protocol) service and outgoing mail delivery, many customers have resorted to simply changing the port number for their mail servers to get their email out. Such use of an ISP to send mass email often violates ISP contractual usage policies, and installation of an SMTP mail server on an alternative port on a dedicated server is not a simple undertaking. That solution is not practical for most organizations.

An alternative means of delivering large amounts of email for senders is needed. Furthermore, senders need to be able to comply with ISP usage policies and still be able to communicate with customers and list members. Since ISPs provide internet services, this invention seeks to leverage off of other internet service protocols and adapt them to the purposes of sending mass email.

Using http as a protocol for delivering email to a mail server is already quite common. Email clients such as hotmail.com allow users to enter in email by hand directly onto a web server on a web page and send from the web server into the email system. The email is edited on a web form and posted via http to the email server. But these systems are not driven by a desktop application. Also, these systems are not designed to send large amounts of email. Additionally, these systems can often carbon-copy one email to many recipients, but that doesn't meet the needs of businesses and organizations which need to protect the recipient email addresses from individual recipients.

Existing email applications do not offer solutions to address the above concerns. Additionally, the use of compression to send email, and specifically mass email from a desktop application to an email server, is currently not used and not practiced in the industry.

FIG. 1 illustrates the prior-art email architecture, and shows the problems that are inherent in current mass mailing systems. A user can use a sending computer 101 to compose a message 105 to be sent to one or more email recipients. A port 25 connection 115 routes message(s) 105 sent as SMTP, Simple Mail Transfer Protocol, or as a proprietary protocol over an internet connection 10, to be received by an ISP email server 120. ISP email server 120 generates email messages to sending computer 101 as an email sending application. The ISP's server bears the burden for email delivery and the ISP may not have the ability to certify their users adequately to avoid email abuse. ISP email server has a dictated email limiter 125 that ISP defined limits represented in FIG. 1 as n. Composed email messages 105 exceeding email limit n dictated by ISP 125 are routed through a port 25 connection 116, returning a blocked reply 130 to sending computer 101, typically accompanied by an automated response notifying the user that the emailing has failed because it was blocked by dictated email limit n 125.

Composed email message(s) 105 received by ISP email server 120 and allowed to pass through email limit n dictated by ISP 125 because the email volume, n, is within ISP defined limits are routed over internet connection 110 via a port 25 connection 117. Email receivers such as an email recipient 1 135, an email recipient 2 140 all the way LIP to an email recipient n 145 are served their email messages via standard email delivery protocols.

Sending mass emails from a sending computer to a server using a proprietary email protocol over a nonstandard port is known in the art. Microsoft developed its Exchange e-mail server and Outlook client for sending email, which operates through a proprietary protocol, for example. Other examples include Lotus Notes, as well as SoftArc's FirstClass. These proprietary systems employ their own protocol for client-server communication and operate on specific internet ports. They each build special-purpose higher level protocols suited to sending email upon the basic low-level TCP-IP based communication protocol for exchanging data.

In view of the foregoing, a need exists to avoid the ISP limitations on bulk emailing from the client sending computers.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a prior-art email architecture, and shows the problems that are inherent in current mass mailing systems; e.g., port-25 blocking and limited bandwidth;

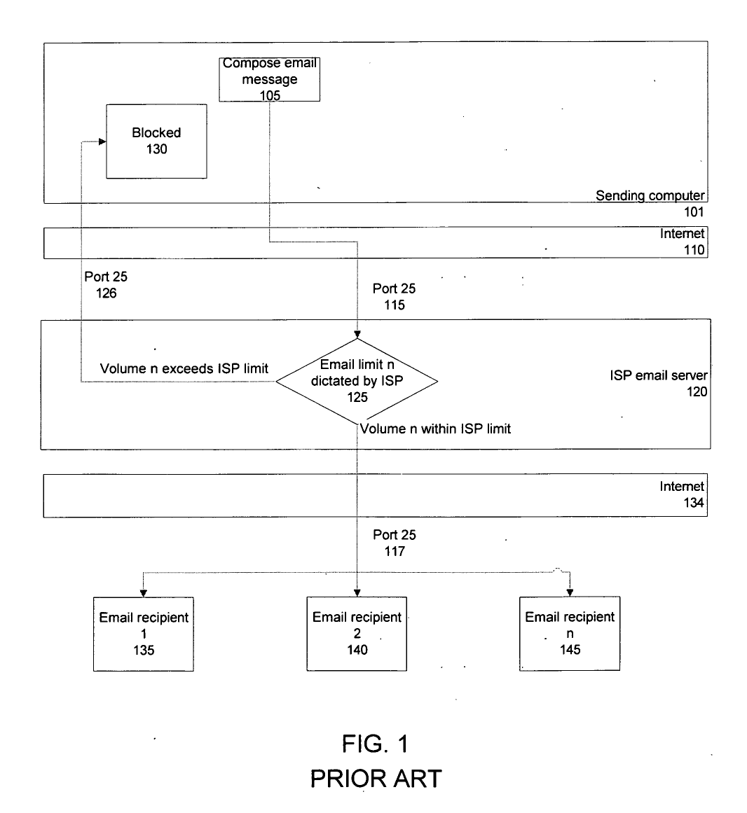

FIG. 2 illustrates an exemplary block diagram of a system that uses HTTP protocol, for example, to send email to an email server via a web post operation or XML, in accordance with an embodiment of the present invention;

FIG. 3 illustrates an exemplary flow chart that carries out compression and target protocol encoding, in accordance with an embodiment of the present invention;

FIG. 4 illustrates a flow chart detailing an exemplary scenario of per-email authentication with the server, individual email generation, and encryption with the novel features of compression and target protocol encoding used to send the message to the server, in accordance with an embodiment of the present invention; and

FIG. 5 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of techniques for the mass transmission of email are described. In one embodiment of the present invention, a method for mass email transmission in a client-server environment, the server being remotely located from the client, the method includes the steps of preparing and sending at least one email content by a client computer over a protocol not traditionally designed for email transmission that is received by a bulk emailing server computer using the non-email protocol. The bulk emailing server, preparing at least one bulk email message based on the received email content and then populates a bulk email recipient list with at least one destination email address that is used by the bulk emailing server for sending a plurality of at least one email massages to an email destination address in the bulk email recipient list, wherein the bulk email sending is performed using a standard email protocol.

In other embodiments of the present invention, a system and software code for implementing the above method is provided

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

An embodiment of the present invention exists in an environment containing a computer system and software from which individual emails generated in bulk are sent to recipients, and a server, through which the emails are delivered to each recipient via standard email delivery protocols. However, unlike conventional approaches, the present invention repurposes other standard high level protocols, such as, without limitation, the HTTP protocol for communicating information over the World Wide Web, for the purpose of sending email.

The specific kind or nature of the hardware of the computer system does not affect the utility or applicability of the present invention, as long as it has some means of sending information through any protocol to another computer system, the server, which itself is connected to the internet.

The specific kind or nature of the email software does not affect the utility or application of the present invention as long as it is designed to send a batch of emails. A batch emailing can be one or more individual emails prepared in any way for sending to the email server. The application software prepares one or more emails for sending and communicates the emails to the server for delivery.

An aspect of the present invention provides a means to send mass emails unencumbered by the obstacles outlined in the background section of this disclosure. Specifically, since email senders need to be directly responsible for the email they are sending, and since service providers are limiting the capacity of email, senders still need to reach their contacts via email, this method provides a means for sending email through connection methods and non-monitored protocols that service providers cannot block or restrict without blocking or restricting other non-email services that are of a critical nature to the service provider's business.

Some relevant aspects of the present invention comprise three elements, wherein the exemplary embodiments to follow will teach the use or optional use thereof, the aspects being: Internet ports designated for internet protocols not designed to handle email traffic, by way of example, and not limitation, internet port 80; Internet protocols not designed to handle email traffic, for example http or ftp; and compression to reduce bandwidth in sending the email through those ports or protocols, for example, without limitation, via LZW or Huffman encoding.

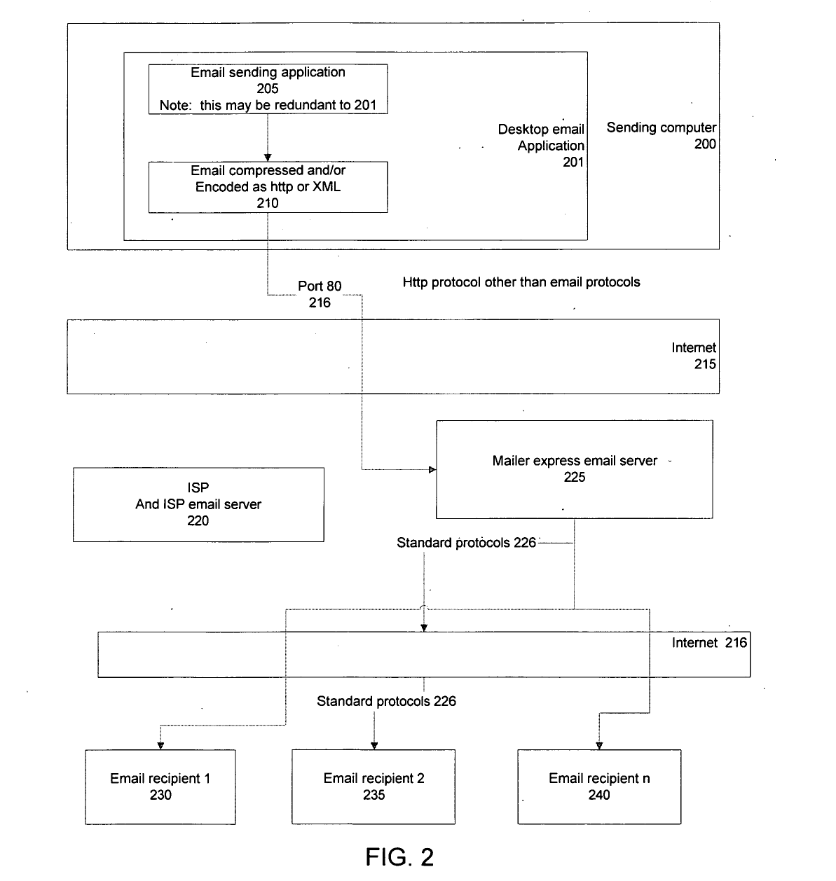

FIG. 2 illustrates an exemplary block diagram of a system that uses HTTP protocol, for example, to send email to an email server via a web post operation or XML, in accordance with an embodiment of the present invention. The method carried out by the following system operation description directly corresponds to the Steps comprised in the present method of sending email via HTTP protocol according to the present embodiment. A desktop email application 201 is installed on a sending computer 200. Desktop email application 201 comprises an email sending application 205, an email compression option utilizing for example, without limitations LZW or Huffman encoding, and an encoding application capable of converting an email message to HTTP or XML 210. Email sending application 205 may comprise email message features such as To:, From:, Subject:, Reply-To:, message body, address book, company data sources, files, etc. Sending computer 200 routes via a port 80 connection 216 over an internet connection 215 an HTTP post request containing email content. Exemplified by port 80 connection 216 is that an HTTP protocol other than email protocols is utilized. Port 80 connection 216 bypasses a user ISP email server 220 delivering the HTTP post request with email content to a mailer express email server 225. Mailer express email server 225 then forwards email messages originating from sending computer 200 via a standard protocol over internet connection 215 to an email recipient 1 230, an email recipient 2 235 if email were sent to more than one email recipient all the way up to an email recipient n 240, n designating the number of intended email recipients.

Because the HTTP post request with email content was sent over port 80 connection 216 and was not treated as conventional email traffic, instead being routed to mailer express email server 225, the ISP bears no burden for email delivery, and typically in practice the ISP cannot distinguish between this new kind of email traffic and other internet traffic over the protocol which the new service uses. Conventional desktop email servers use SMTP protocols, which do not compress email content sent. In some applications, however, it may be desirable for an email message to be compressed and encoded as HTTP or XML at 210 in desktop email application 201. Compression of each email saves considerable bandwidth, potentially reducing costs and increasing sending performance.

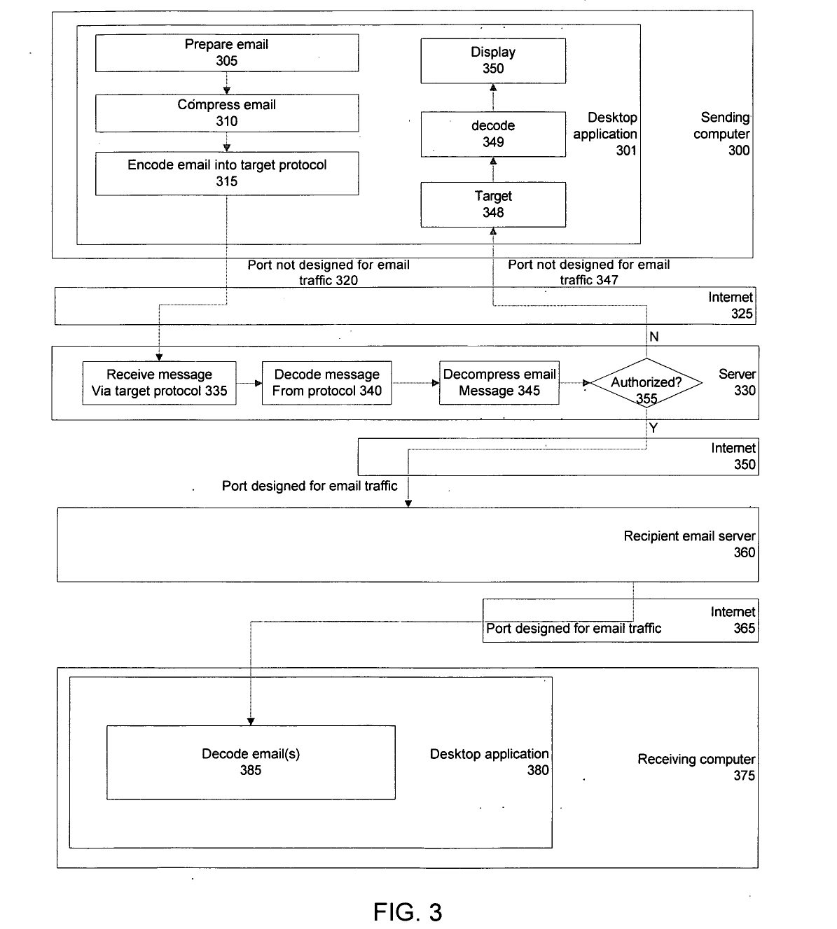

FIG. 3 illustrates an exemplary flow chart that carries out compression and target protocol encoding, in accordance with an embodiment of the present invention. A desktop software application 301 is installed on a sending computer 300. The process begin with desktop software application 301, which at Step 305 prepares an email by, for example, determining the To:, From:, Subject:, Reply-To, and message body of the message, and optionally compresses the email body at Step 310 and then an encodes the email into the target protocol at Step 315 by, for example, converting the binary code into printable characters that can be embedded into an HTML post request, including in the post request Account Name and Password for the server. In this way, a user is enabled by desktop application 301 to reference company data sources and/or files and the desktop application router sends email messages via HTTP protocol through a port not designed for email traffic 320 and over an internet connection 325 to a receiving server 330. Receiving server 330 receives, at Step 335, a consolidated message stream via encoded target protocol to a CGI script, or any other suitable sever programming language and at Step 340 decodes the HTML encoded body of the email message to produce a binary compressed message (for example, stored in CGI variable “Body”) and routes the email message for decompression at Step 345. It should be noted that, in the http protocol, a web server normally handles the process of preparing the CGI environment variables so that any posted variables are available to the CGI script. Continuing now with flow chart, at Step 355 Server 330 optionally checks the Account Name and Password associated with the decompressed message to determine access authorization. If not authorized, an error code is print to an HTML result page and sent back to sending computer 300 by encoding the HTML page and transmitting the encoded page over a port not designed for email traffic 347 to sender's desktop application 301 for HTML target protocol reception at Step 348 and protocol content decoding at Step 349 for result display at Step 350, where the process ends.

If access, at Step 355, is authorized, the decompressed email message is again encoded into a target protocol and concatenate the email header information (To, Subject, Reply To, From, etc.) with the Body, and at transmits the encoded email message over an internet connection 350 via a port designed for email traffic to a receiving computer 375 or in some applications, an intermediate email server 360, which intern delivers the email message to receiving computer 375 by conventional email delivery means, which includes known email programs such as, without limitation, if Using sendmail, simply invoking sendmail with the prepared message. Typically, comprised within receiving computer 385 is a desktop application 390 that comprises a decode email send result application 380 that decodes 385 the email message for display to the recipient.

Upon a successful email delivery by server 330 to the recipient's email server 370, server 330 optionally may generate a result statistics web page and deliver it via the port 347 to sending computer 300 for a status report outlining the success and/or failures in delivering the email message(s) received at Step 335, where afterwards the process ends until a new batch of emails messages are received for distribution.

Some embodiments of the present invention implement a challenge-response means of authentication between the application and the web server to avoid sending the account password to the web server over a non-encrypted protocol. An alternate implementation can use https (secured by SSL between application and server) to protect not only the account authorization but also the message content. However, use of this protocol may impose extra overhead, and is not really necessary since beyond the server, email is conveyed via SMTP unencrypted anyway.

Note that the present invention does not depend in any way on any sort of authentication or encryption, and such steps are completely optional.

In some alternate embodiments of the present invention, the sending computer's application software may prepare more than one email for sending at one time, and can send the emails one at a time, in batches of a fixed or variable number, or all emails in one send operation.

In an embodiment of the present invention, sending all emails in one sending operation allows a compression algorithm to make use of redundancy in duplicated email content among messages, achieving an overall reduction in the amount of data to be sent. An exemplary approach to facilitate compression is to prepare all messages for sending by composing the message header and body of each message (the To:, From:, Subject:, Reply-To, and message body of the message) and concatenating them all together using a unique separator X (such as a character code not contained in any of the email headers or bodies) to thereby compose a message stream. Those skilled in the art will recognize a multiplicity of other efficiencies that can be achieved in light of the teachings of the present invention.

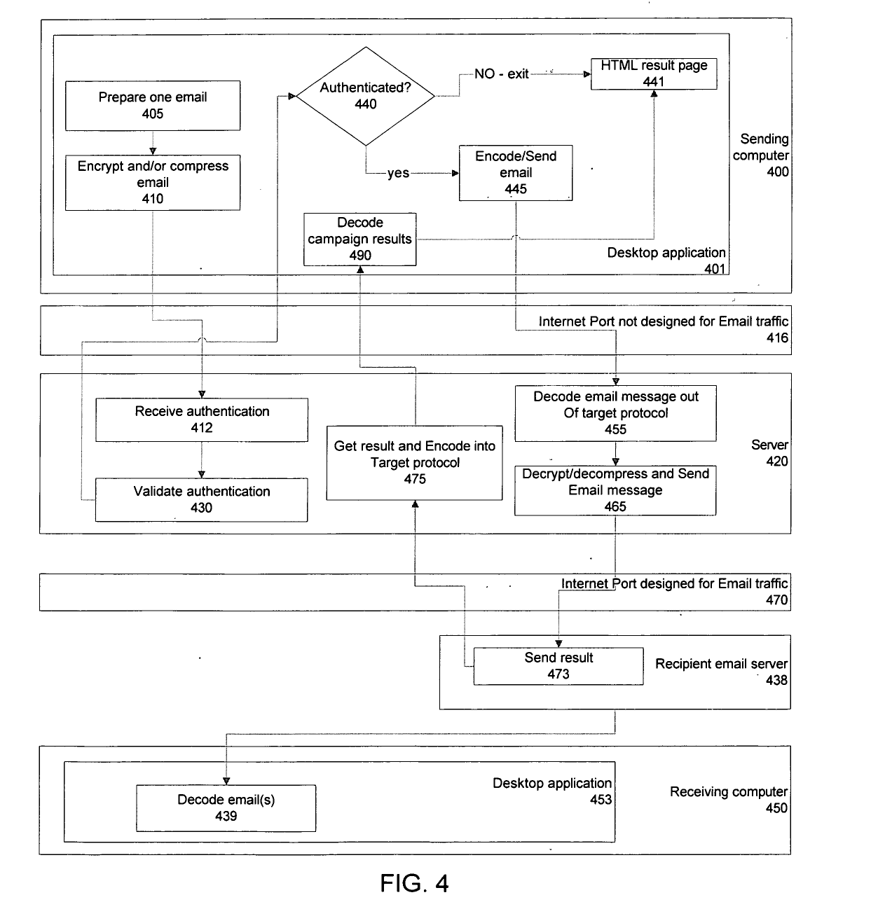

FIG. 4 illustrates a flow chart detailing, by way of example, a scenario of per-email authentication with the server, individual email generation, and encryption with the novel features of compression and target protocol encoding used to send the message to the server, in accordance with an embodiment of the present invention.

A sending computer 400 utilizes a desktop application to prepare one or more email messages at Step 405. Prepared messages are forwarded to a mail encrypt and/or compression at Step 410 on the desktop application advancing to a target protocol at Step 415 that is capable of HTML encoding the message stream, converting the binary code into printable characters that can be embedded into an HTML post request. Encode the message stream as an http post request, with variable message stream and separator X, including in the post request Account Name and Password for the server and send the post request to a web server 420 via an internet connection 416 over port 80 to a CGI script on server 420.

Sending computer 400 receives the HTML result page from server 420 over port 80, which details the send result of each message in the message stream.

Server 420 performs the following algorithm in the CGI. Note that, via http, a web server normally handles the process of preparing the CGI environment variables so that any posted variables are available to the CGI script.

Server 420 checks the Account Name and Password for authorization to send and sends a check result at Step 430 over a port 80 connection via internet 416 to sending computer 400 over a target protocol at Step 435. If a check is not authorized or authenticated at 440, the process ends and an error code is printed to a display at 441; e.g. an HTML result page is displayed on a computer monitor.

At Step 445, an authenticated check is encoded into a target protocol and sending computer 400 sends to server 420 a checked email message over target protocol via a non-email port, for example, connection, over internet 416. Server 420 receives a target protocol message and an application decodes the HTML encoded message stream at Step 455. At Step 465, the message stream is decompress and/or decrypted as needed and then for each message a send mail application on server 420 forwards mail through whatever conventional email sending mechanism is present on the server to a recipient email server, e.g., without limitation, Internet Port designed for Email traffic 470. For example, without limitation, if using sendmail, simply invoke sendmail with the prepared message. In some embodiments, prior to sending out the email(s), server 420 splits the message stream into individual messages using the unique separator X.

The recipient email server 438 delivers the email(s) to a recipient 450 using normal email protocols and the recipient decodes/receives the email(s) at Step 439. The recipient email server 438 additionally returns a result to server 420 at Step 473 to confirm the delivery success or failure of the email(s) sent and appends the result to an HTML result page to be delivered to sending computer 400. Some email servers may only return failure results.

Server 420 receives the status results of prior email(s) sent, and at Step 475 and encodes this email campaign information (e.g., email campaign delivery success/failure statistics) into a target protocol and delivers it to sending computer 400 preferably using a non-email port such as, without limitation, a port 80 connection over internet 416. However, is some alternate embodiments of the present application, it may be desirable for campaign results to be sent using conventional email ports; e.g., this may be useful if the campaign results are compiled into one large email and does not generate a high volume of email traffic that ISP's might have a problem with. At Step 490, sending computer 400 receives and decodes the email campaign results and displays it at Step 441, where the process ends.

In some applications of any of the foregoing embodiments, more than one server may simultaneously cooperate with the desktop application according to the teachings of the present invention.

Those skilled in the art will readily recognize in light of the teachings of the present invention that, depending upon the needs of the particular application, in any of the forgoing steps, steps may be suitably added, removed, modified, swapped, etc., while keeping in accordance with the spirit of the present invention.

Some embodiments of the present invention implement a protocol commonly accepted for the port over which the email is to be sent. For example, without limitation, http protocol traffic for the World Wide Web is generally and traditionally conveyed over port 80.

An embodiment of the present invention utilizes a system that may use a proprietary protocol (not http) but over an internet port designated for an alternative protocol not designated for email (as is port 80).

Some embodiments of the present invention may implement a nonstandard port for a protocol not designed for sending email, such as http over port 81.

Some embodiments of the present invention may implement a standard protocol or standard port and employ data compression techniques to reduce bandwidth. Certain embodiments of the present invention preferably do not send hand-composed emails over non-email protocols or ports from a computer system to a server. For example, without limitation, the preferred embodiment of the present invention does not use web-based email interfaces, wherein a user types out a single fixed-content email message sent to one or more recipients into a web form or browser software application, and submits the email message via HTTP to a server for delivery. Some well-known web-based email interface examples include, but are not limited to, Google™ mail, Hotmail™, and Yahoo™, as well as other mass email delivery systems where the user types the message body and merge fields into a web page, uploads the data, and submits, and the server generates the individual emails. Although these services are common, they, unfortunately, do not easily allow for local email origination and database integration. If such services were eventually offered in the marketplace, however, embodiments of the present invention could be adapted for use therewith.

Embodiments of the present invention may be carried out on a laptop, personal-digital-assistant, workstation, or any computer system capable of generating multiple email messages from a data set, and may connect to a locally or remotely stored data set for generation of emails.

Alternate embodiments of the present invention may utilize protocols other than HTTP, such as, without limitation, FTP, SSH, RCP (remote copy), secure remote copy, JABBER (for chat services), and many others. Moreover, while the embodiments were described in the context of an HTML and Internet URL examples, the present invention is not limited to such implementation details, and any suitable non-email communication and information sharing/display means may be used.

An embodiment of the present invention encodes the account information within each message. An embodiment of the present invention may encode service or email user account and authentication information with each message. Some embodiments of the present invention may send a username and/or password with each message, or exchange a secure key, or perform a challenge-response authentication, in order to establish that the originator of the email is authentic, and to perform accounting of email sending usage.

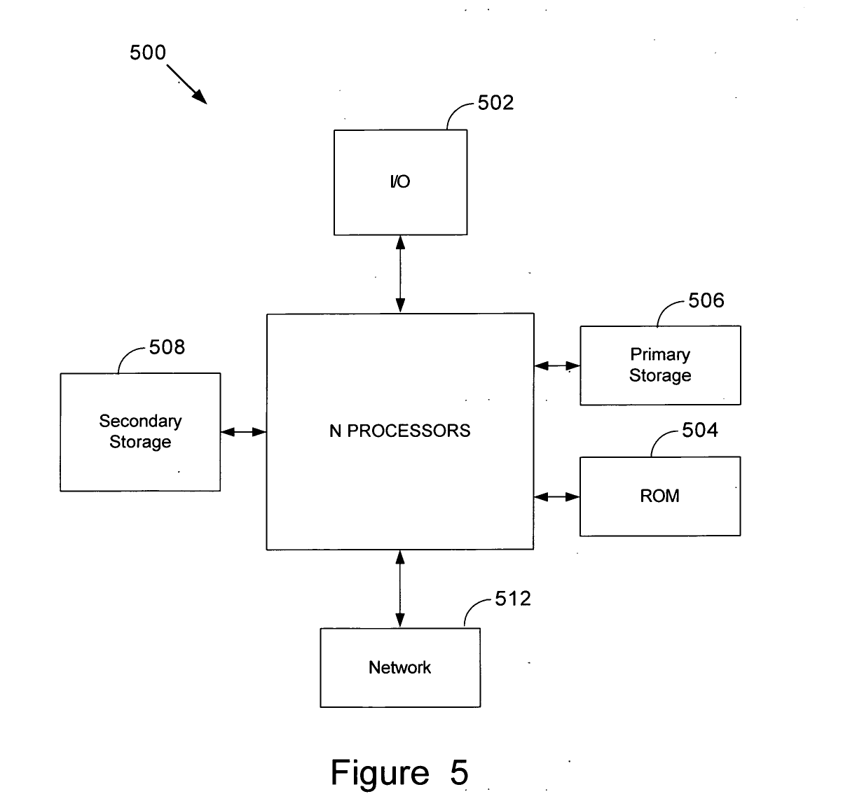

FIG. 5 illustrates a typical computer system that, when appropriately configured or designed, can serve as a computer system in which the invention may be embodied. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers and microprocessors such as programmable devices (e.g., CPLDs and FPGAs) and unprogrammable devices such as gate array ASICs or general purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection as shown generally at 512. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, firmware, microcode and the like.

Having fully described at least one embodiment of the present invention, other equivalent or alternative methods of implementing mass email transmission according to the present invention will be apparent to those skilled in the art. For example, any computer system that sends multiple emails in a batch or designated as a single send operation, even if generated elsewhere or beforehand for sending, is considered to be within the scope of this invention. Moreover, those skilled in the art will readily recognize that the present invention is adaptable to operate upon computer systems that encrypt, divide, or obfuscate the emails sent between the sending machine and the server, but also combining these features with one of the above embodiments is contemplated to be within the scope of the present invention. The invention has been described above by way of illustration, and the specific embodiments disclosed are not intended to limit the invention to the particular exemplary forms disclosed. The invention scope includes all modifications, equivalents, and alternatives falling within the spirit and scope of the following claims.

What is claimed is:

1. A method for mass email transmission in a client-server environment, the server being remotely located from the client, the method comprising the Steps of:
preparing and sending at least one email content by a client computer, wherein the sending is performed using a protocol not traditionally designed for email transmission;
receiving said at least one email content by a bulk emailing server computer using said non-email protocol;
said bulk emailing server, preparing at least one bulk email message based on said at least one email content;
said bulk emailing server, populating a bulk email recipient list with at least one destination email address; and
said bulk emailing server sending a plurality of said at least one email massage to an email destination address in said bulk email recipient list, wherein said bulk email sending is performed using a standard email protocol.

2. The method for mass email transmission of claim 1, further comprising the Step of the client computer sending configuration information to said bulk email server prior to said bulk emailing server preparing said at least one bulk email message.

3. The method for mass email transmission of claim 2, wherein the Step of said bulk emailing server preparing and/or populating is/are performed at least in part based upon said configuration information.

4. The method for mass email transmission of claim 1, wherein the non-email protocol is the HTTP protocol.

5. The method for mass email transmission of claim 1, further comprising the Step of the client computer compressing said at least one email before sending to said bulk email server.

6. The method for mass email transmission of claim 5, further comprising the Step of said bulk emailing server decompressing said at least one email after receiving it.

7. The method for mass email transmission of claim 1, further comprising the Step of after the sending Step by said bulk emailing server, said bulk emailing server sends email delivery confirmation information to said client computer, which information was received from an email sever that received at least one of the sent emails.

8. The method for mass email transmission of claim 1, further comprising the Step of said bulk email server, prior to sending out the at least one email message(s), splitting said email message into a plurality of individual messages based on a unique separator.

9. The method for mass email transmission of claim 1, further comprising the Step of said bulk email server authorizing said client for use of said bulk email server.

10. The method for mass email transmission of claim 1, wherein the Step of sending by said bulk email server or the client all emails are sent in one sending operation.

11. A system for mass email transmission in a client-server environment, the server being remotely located from the client, the system comprising:
means for preparing and sending at least one email content by a client computer to a bulk emailing server;
means for receiving said at least one email content by said bulk emailing server;
means for said bulk emailing server, preparing at least one bulk email message based on said at least one email content;
means for said bulk emailing server, populating a bulk email recipient list with at least one destination email address; and
means for said bulk emailing server sending a plurality of said at least one email means for massage to an email destination address in said bulk email recipient list, wherein said bulk email sending is performed using a standard email protocol.

12. The system for mass email transmission of claim 11, further comprising means for said bulk emailing server sending email delivery confirmation information to said client computer.

13. A computer program product for mass email transmission in a client-server environment, the server being remotely located from the client, the computer program product comprising:
computer code on a by a client computer that prepares and sends at least one email content, wherein the protocol for sending is one not traditionally designed for email transmission;
computer code on a bulk emailing server that receives said at feast one email content computer using said non-email protocol;
computer code on said bulk emailing server, that prepares at least one bulk email message based on said at least one email content;
computer code on said bulk emailing server, that populates a bulk email recipient list with at least one destination email address;
computer code on said bulk emailing server that sends a plurality of said at least one email massage to an email destination address in said bulk email recipient list, wherein said bulk email sending is performed using a standard email protocol;
a computer-readable medium that stores the computer code.

14. The computer program product for mass email transmission of claim 13, further comprising computer code on the client computer that compresses said at least one email before sending to said bulk email server.

15. The computer program product for mass email transmission of claim 13, further comprising computer code on said bulk emailing server that decompresses said at least one email after receiving it.

16. The computer program product for mass email transmission of claim 13, further comprising computer code on said bulk emailing server that sends email delivery confirmation information to said client computer, which information was received from an email sever that received at least one of the sent emails.

17. The computer program product for mass email transmission of claim 13, further comprising computer code on said bulk email server that, prior to sending out the at least one email message(s), splits said email message into a plurality of individual messages based on a unique separator.

18. The computer program product for mass email transmission of claim 13, further comprising computer code on said bulk email server or the client that sends all emails in one sending operation.

19. The method for mass email transmission of claim 13, wherein the non-email protocol is the HTTP protocol.

20. A computer program product according to claim 13, wherein the computer-readable medium is one selected from the group consisting of a data signal embodied in a carrier wave, an optical disk, a hard disk, a floppy disk, a tape drive, a flash memory, and semiconductor memory.
